(19) United States
(12) Patent Application Publication
(10) Pub. No.: US 2016/0272477 A1
(43) Pub. Date: Sep. 22, 2016

(54) Flexible package having a dispensing bag and a hose spout

(71) Applicant: ScholleIPN Corporation, Northlake, IL (US)

(72) Inventors: David Bellmore, DeWitt, MI (US); Chris Murray, Chicago, IL (US)

(21) Appl. No.: 15/042,508

(22) Filed: Feb. 12, 2016

Related U.S. Application Data
(63) Continuation-in-part of application No. 14/535,211, filed on Nov. 6, 2014.
(60) Provisional application No. 61/915,003, filed on Dec. 12, 2013.
(60) Provisional application No. 61/900,780, filed on Nov. 6, 2013.

(51) Int. Cl. B67D 3/00; B65D 77/06

(52) U.S. Cl. CPC B67D 3/0067; B65D 77/06; B67D 3/0083

(57) ABSTRACT

A flexible package for positionable within a vessel having an outlet with a valve dispensing member. The flexible package includes a dispensing bag and a hose spout. The dispensing bag includes a panel and a seal defining a cavity with an open top and an opening extending through the panel. The opening is spaced apart from the open top and the at least one seal. The hose spout includes an integrally molded flange and an elongated spout of a uniform material. The elongated spout extends from the molded flange and together defines an elongated channel with a proximal end and a distal end. The proximal end corresponds to the molded flange. The inner outer surface of the molded flange is coupled to the inner surface of the dispensing bag by a seal with the elongated spout extending through about the opening thereof.

### CROSS-REFERENCE TO RELATED APPLICATION

This application is a continuation-in-part of U.S. patent application Ser. No. 14/535,211, filed Nov. 6, 2014, which claims priority from U.S. Prov. Pat. App. Ser. No. 61/900,780 filed Nov. 6, 2013 entitled “Dispensing Bag Having A Hose Spout,” and U.S. Prov. Pat. App. Ser. No. 61/915,003 filed Dec. 12, 2013, entitled “Dispensing Bag Having A Hose Spout”, the entire disclosure of each of which is hereby incorporated in its entirety.

### BACKGROUND OF THE DISCLOSURE

1. Field of the Disclosure

The invention relates in general to flexible packaging, and more particularly, to a flexible package having a dispensing bag with a hose spout which can be positioned within a generally rigid outer vessel or urn having a valve, wherein, the hose spout extends through the valve. Such a configuration precludes contact between the outer vessel and the liquid within the bag.

2. Background Art

It has become commonplace to offer iced tea and other non-carbonated beverages to customers at fast food and premium fast food restaurants. For example, many establishments have a large vessel positioned typically on a counter. The vessel has a tap that extends from the vessel for purposes of dispensing. The vessel is filled with a drink, typically a non-carbonated beverage such as iced tea, sweet tea, lemonade, etc. The user can selectively dispense the fluid from the vessel through the valve.

Problematically, when the vessel is emptied, it is typically required to be cleaned and refilled. It is often difficult to properly clean the vessel and the valve. Many times, later drinks are contaminated with either the prior contents of the vessel, bacteria or other debris that has accumulated within the vessel.

Certain solutions have been developed to minimize the need to wash and prepare the vessel for each subsequent refilling and use. For example, one solution is disclosed in U.S. Pat. No. 4,516,693 issued to Gaston. Such a solution relies upon a modified liner that has a spout that is formed from the liner material itself. Such a solution is difficult to properly position and use due to the natural characteristics of the liner material when formed into a spout.

Another solution is disclosed in U.S. Pat. No. 6,116,467 as well as U.S. Pat. App. Pub. Nos. 2010/0200613 and 2013/0037568. These publications disclose a bag having a spout that comprises a multi component spout. Such spouts generally include multiple components that require assembly and which are prone to failure or degradation due to the connections between the bag and the components of different rigidity. Each of the foregoing publications and issued patent are incorporated in their entirety herein.

### SUMMARY OF THE DISCLOSURE

The disclosure is directed to a flexible package for positionable within a vessel having an outlet controlled by a valve dispensing member. The flexible package includes a dispensing bag and a hose spout. The dispensing bag includes at least one panel and at least one seal defining a cavity with an open top and an opening extending through the at least one panel. The opening is spaced apart from the open top and spaced apart from the at least one seal. The panel includes an inner surface surrounding the opening, and an outer surface surrounding the opening. The hose spout includes an integrally molded flange and an elongated spout of a uniform material. The elongated spout extends from the molded flange and together defines an elongated channel with a proximal end and a distal end. The proximal end corresponds to the molded flange. The molded flange has an inner outer surface. The inner outer surface of the molded flange is coupled to the inner surface of the dispensing bag by a seal in sealed engagement with the elongated spout extending through about the opening thereof.

In some configurations, the at least one panel comprises a front panel and a back panel. The at least one seal includes a bottom seal and opposing first and second side seals extending therefrom. The panels and the at least one seal define an open top opposite the bottom seal, thereby defining a substantially rectangular pillow bag.

In some configurations, the opening is positioned on the front panel closer to one of the first side seal and the second side seal from the other of the first side seal and the second side seal, and closer to the bottom seal than the open top, while being spaced apart from each of the first side seal, the second side seal and the bottom seal.

In some configurations, the opening is positioned closer to one of the first side seal and the second side seal than to the bottom seal.

In some configurations the opening is positioned closest to the second side seal, than to the bottom seal and closer to the bottom seal than the first side seal.

In some configurations, the seal is spaced apart from an outer perimeter of the flange of the hose spout, and spaced apart from the opening in the front panel.

In some configurations, the hose spout includes a transition region that joins the elongated spout and the flange. The transition region has a diameter greater than the elongated spout. The opening in the front panel is larger than the transition region of the hose spout so as to be spaced apart therefrom.

In some configurations, the flange is substantially planar with the elongated spout being substantially perpendicular thereto.

In some configurations, the elongated spout includes a peak region, with the peak region oriented toward the bottom seal of the dispensing bag.

In some configurations, the peak region defines a point.

In some configurations, the outer surface of the flange is substantially planar with the elongated spout being substantially perpendicular thereof.

In some configurations, the elongated spout is multiple times longer than a largest dimension of the flange.

In some configurations, the flange is substantially circular, with the elongated spout being substantially perpendicular thereto.

In some configurations, the flange has a thickness that is greater than a thickness of the at least one panel about the opening.

In some configurations, the seal is a heat seal.

### BRIEF DESCRIPTION OF THE DRAWINGS

The disclosure will now be described with reference to the drawings wherein:

FIG. 1 of the drawings is a front elevated view of the dispensing bag and hose spout of the present disclosure;

FIG. 2 of the drawings is a cross-sectional view of the dispensing bag and hose spout of the present disclosure taken generally about lines 2-2 of FIG. 1;

FIG. 3 of the drawings is a perspective view of the hose spout of the present disclosure;

FIG. 4 of the drawings is a side elevational view of the hose spout of the present disclosure; and

FIG. 5a of the drawings is a perspective view of a hose spout of the present disclosure;

FIG. 5b of the drawing is a cross-sectional view of the hose spout of FIG. 5a;

FIG. 6a of the drawings is a side elevational view of the hose spout of the present disclosure;

FIG. 6b of the drawings is a cross-sectional view of the hose spout of FIG. 6a;

FIG. 7 of the drawings is a schematic representation of the dispensing bag and hose spout of the present disclosure positioned within a vessel or urn with a valve dispensing member;

FIG. 8 of the drawings is a perspective view of a configuration of the hose spout of the present disclosure;

FIG. 9 of the drawings is a cross-sectional view of a configuration of the hose spout of the present disclosure;

FIG. 10 of the drawings is a cross-sectional view of a configuration of the hose spout of the present disclosure;

FIG. 11 of the drawings is a top plan view of a container of the present disclosure;

FIG. 12 of the drawings is a partial perspective view of the container of the present disclosure, showing, in particular, the sealing of the hose spout to the dispensing bag; and

FIG. 13 of the drawings is a perspective view of a pair of containers coupled in a side by side configuration.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

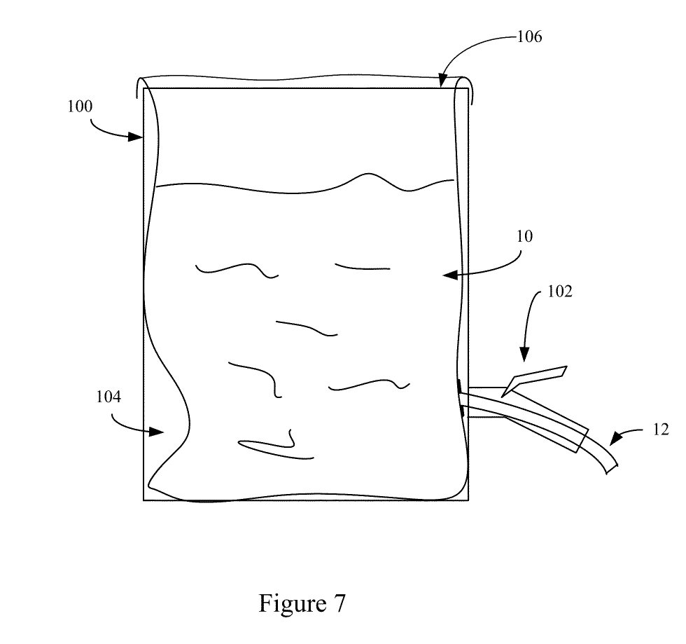

Referring now to the drawings and in particular to FIG. 1, the disclosure is directed to a dispensing bag 10 having a hose spout 12 coupled thereto which defines a flexible package 9. The hose spout is integrally coupled to the dispensing bag. The dispensing bag is positioned within an outer vessel or urn, such as urn 100 (FIG. 7) having a valve dispensing member 102 (FIG. 7). The hose spout 12 is extended through the valve dispensing member 102. The filled container can be emptied through the hose spout 12, which dispensing fluid flow can be controlled by the valve dispensing member 102. As will be explained below, such a container is useful for the dispensing of, for example, brewed iced tea, lemonade or the like (generally non-carbonated beverages). Of course, the disclosure is not limited to the foregoing, but, can be utilized in association with any number of different fluids and flowable materials. It is contemplated that such a flowable material may comprise any number of different viscosities, and may include a solids content. The foregoing examples of flowable material are meant to be illustrative, and not deemed to be limiting.

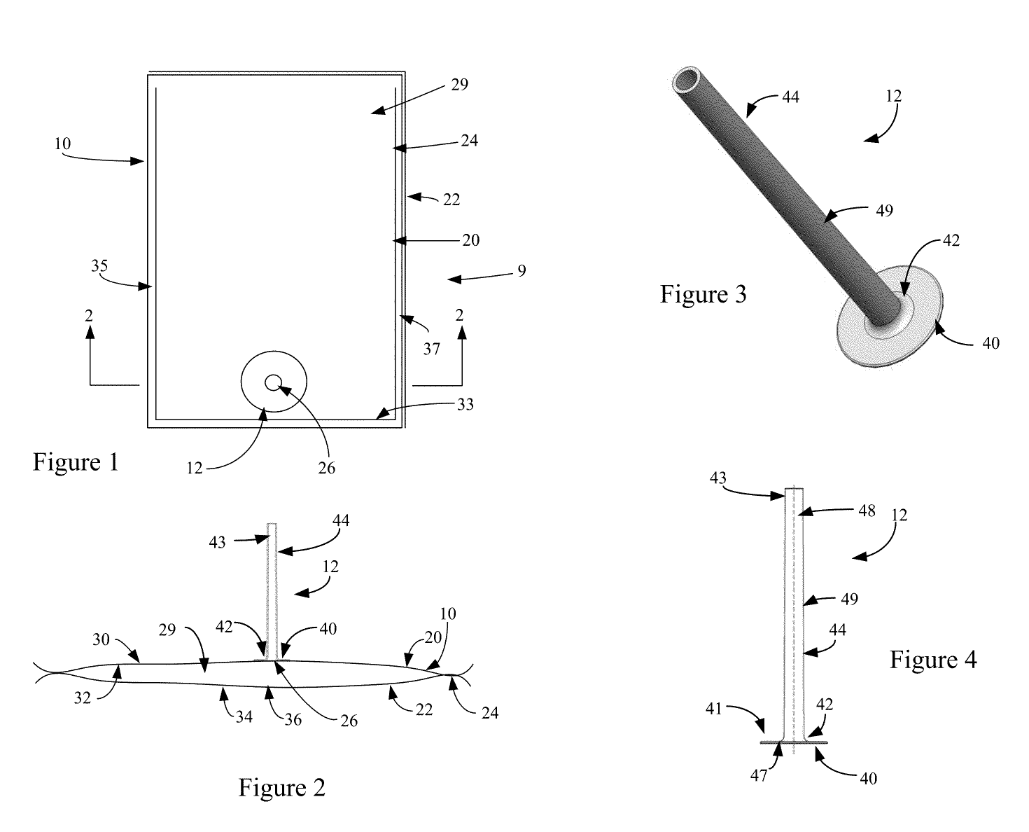

One illustrative dispensing bag is shown in FIGS. 1 and 2 as comprising an open top pillow type bag. Such a bag includes front panel 20 and back panel 22. Front panel 20 includes outer surface 30 and inner surface 32. The back panel 22 includes outer surface 34 and inner surface 36. The front and back panel are positioned in an overlying orientation so that the inner surfaces face each other. Generally, the two panels are co-extent and generally identically dimensioned, although such a relationship is not required. Generally, such a configuration is a single ply, although multiple ply containers are likewise contemplated. In addition, it is contemplated that the pillow type bag may comprise any number of different laminated and coextruded film structures, or combinations thereof.

The panels are then coupled together by way of seals 24. In the case of a pillow type container, the seals 24 include bottom seal 33, first side seal 35 and second side seal 37. The seals are generally perpendicular to adjacent seals and parallel to opposing seals to generally define an open top square or rectangular configuration, thereby defining a generally square or rectangular cavity 29, again with an open top. The seals may be formed through the application of heat, or through other procedures, including, but not limited to RF welding, ultrasonic welding, adhesive, among others. The disclosure is not limited to any particular manner of attachment of the panels. It will also be understood that while a rectangular configuration is contemplated, a number of different configurations are contemplated, including, but not limited to trapezoidal configurations, parallelograms, and the like. The configuration of the panels and the seals is not limited to the parallel and perpendicular relationship disclosed herein. In another configuration, the side seals may comprise folds wherein the flexible bag is formed from a tubular member that is sealed at the bottom by way of a bottom seal, and when folded into a lie flat configuration, comprises a pair of opposing, and substantially parallel folds that mimic the side seals of the flexible bag in the embodiment shown. The side opposite the bottom seal forms the open top in such a configuration.

It is contemplated that in certain embodiments, a top seal may be provided which can be removed by cutting just below the top seal from the first side seal 35 to the second side seal 37. In such a configuration, a cavity 29 can be provided in a sterilized manner which sterilization is only affected when the top is cut (effectively turning the bag into an open top bag. In other embodiments, a perforation may be provided generally parallel to the top seal and spaced apart therefrom to assist with such a cut. In other embodiments, a starting notch may be positioned, wherein the bag is configured to rip along a line that is generally parallel to top seal.

Referring again to FIGS. 1 and 2, the bag 10 further includes opening 26 provided through the front panel 20 proximate, but spaced apart from the bottom seal 33. Hose spout 12 is placed in fluid communication with the opening 26, as will be disclosed below. In addition, a welding region is defined around opening 26.

Hose spout 12 is shown in FIGS. 2 through 6b as comprising a monolithic member having an inside surface 47 and an outside surface 49. Generally, the hose spout comprises a flexible injection molded member, although other constructions are contemplated. While a number of different polymer materials are contemplated, such as, for example, a styrene ethylene butylene styrene (SEBS) material, a styrene butadiene styrene (SBS) material, urethanes, among others, all of which provide a flexibility but with a rigidity that is greater than the flexible bag at the thickness of the bag relative to the spout (the rigidity being sufficient to direct the hose spout through a valve dispensing member). The particular material from which the hose is made is not limiting, as long as the hose and the bag are of compatible materials which can be coupled together to in a sealed fashion, or through an intermediary. That is, the hose spout, through the base flange 40 is coupled to the region around opening 26, either directly through welding, adhering, sealing, among other solutions, or indirectly through a intermediate component which is compatible with each (i.e., a film structure or the like). The resulting bag is formed from the hose spout being coupled to the bag so as to form an integrated combination. Generally, the separation of the hose spout from the bag is a destructive process due to the attachment of one to the other.

The hose spout 12 includes base flange 40, transition region 42 and elongated spout 44. The flange generally comprises a substantially uniformly thick member (with a thickness of between 0.5 mm to 3mm, and more preferably about 0.70 and 0.90 mm) having a diameter of, for example, between 10 and 50 mm, and more preferably between 30 and 40 mm), although smaller and larger flanges are contemplated. The inside surface of the flange includes an attachment surface which is configured to attach to the welding region around opening 26. In the embodiment shown, the base flange is generally planar, although, it is contemplated that the base flange may be conical in configuration, or that it may follow a particular contoured configuration for a particular application (so as to fit into a particularly configured vessel/valve configuration). It will be understood that the base flange of the hose spout can be heat sealed, adhered, or otherwise attached to the outside surface of the bag about the welding region so as to provide a fluid tight bond therebetween.

The elongated spout 44 generally extends perpendicularly from the base flange 40 with a transition region 42 spanning therebetween, so as to insure the transition from the flange to the spout. The transition region may have an increased thickness as it transitions from the flange to the elongated spout, and may have a filleted radius of approximately 1 to 4 mm, and more preferably about 3 mm. It will be understood that these structures define elongated channel 48 therein. It is contemplated that the length of the elongated spout is between 100 mm and 250 mm and more preferably between 120 and 150 mm. Of course, other dimensions are likewise contemplated. It is contemplated that the diameter of the elongated spout is between 8 mm and 11 mm, and more preferably about 9.3 mm. The elongated channel has a diameter of approximately 6.9 mm in such a configuration leading to a wall thickness of approximately 1.2 mm. The elongated spout may also be oblique to the flange (such that it is angled at a particular angle). The elongated spout may comprises a generally linear configuration (although the flexibility of the material will tend to bend under force, such as the force of gravity). It is also contemplated that the elongated spout may be molded into a curved or segmented configuration when in an unstressed state. The elongated spout may be slightly inwardly tapered along the length thereof between proximal end 41 and distal end 43. It will be understood that in other embodiments, the cross-sectional configuration may be uniform along the length thereof, or may be varied by providing different elongated channel cross sectional area, shape, as well as different wall thicknesses of the elongated spout. Additionally, in the embodiment shown, although not required, the elongated spout extends generally about the central axis of the flange. Additionally, the elongated spout is multiple times longer than the diameter of the flange, or the largest dimension of the flange (wherein the flange is not circular or the like). Additionally, the diameter of the flange (or the largest dimension of the flange) is preferably at least two times that of the elongated spout.

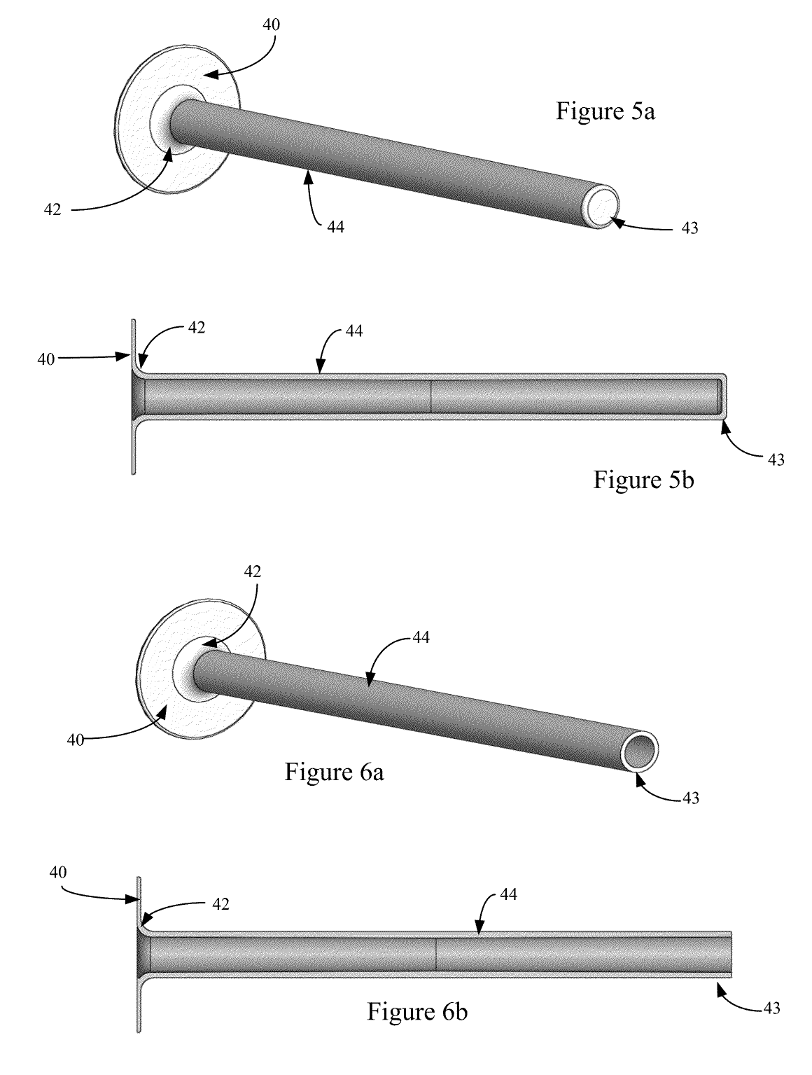

At the distal end 43 of the elongated spout 44, the end may be open so as to allow fluid communication with the cavity 29. In other embodiments, as is shown in FIGS. 5a and 5b, the distal end 43 may be closed, wherein puncturing, cutting or the like will be required prior to dispensing. In other embodiments, a particular type of valve opening may be provided, such as particular scoring, or the like to provide a particular type of dispensing characteristics at the distal end. A number of different opening configurations are contemplated (in addition to that which is shown in FIGS. 6a and 6b, namely, a cross, snowflake or duckbill configuration to name a few).

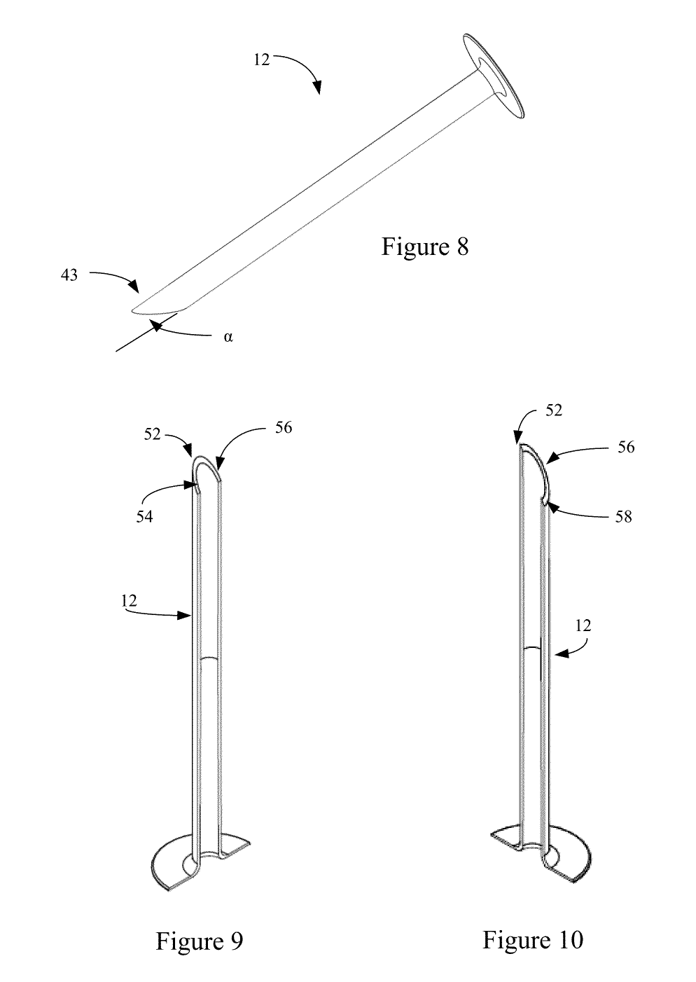

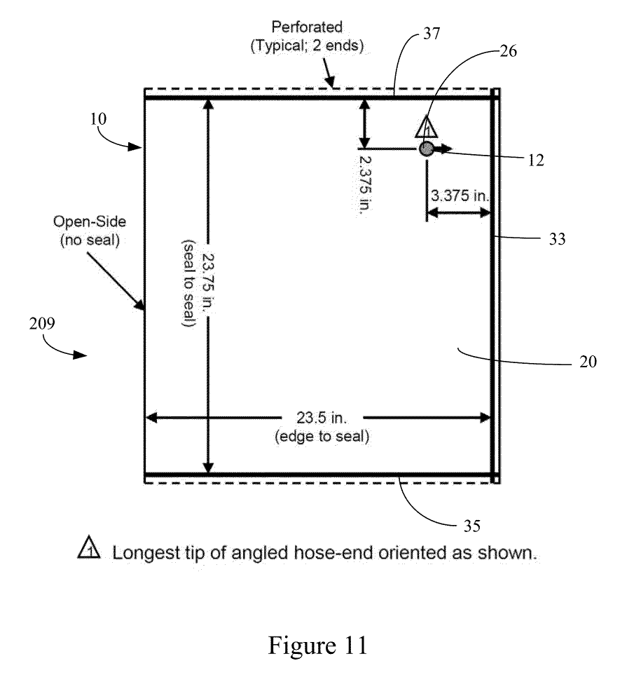

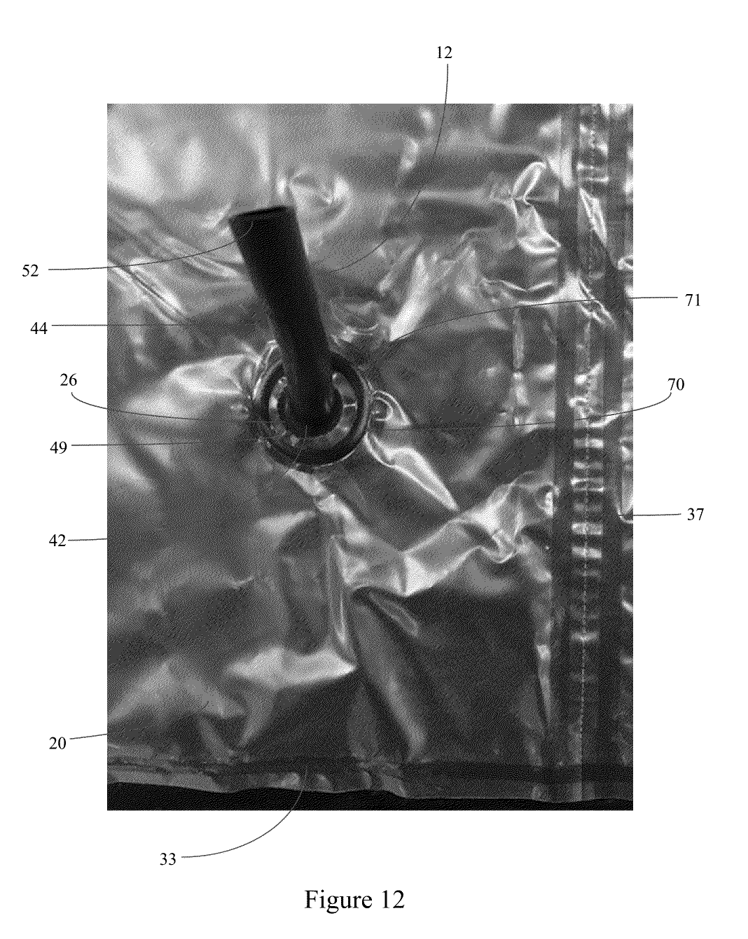

In another embodiment of the disclosure, with reference to FIGS. 8 through 10, the distal end 43 is configured so as to include peak region 52 flanked by sides 54, 56 and opposite of valley region 58. In the embodiment shown, the distal end 43 is essentially formed at an oblique angle with respect to the axis of the spout, or at an angle relative to the flow therethrough. It will be understood that in different embodiments, the angles, such as angle a, may be different, and may be varied due to variations in the spout. Angles of approximately 10° and 65° are contemplated, with a more preferred angle being between 15° and 40°, and more preferably approximately 30°. In the embodiment shown, the peak region is curved so as to present a pointed surface that is generally free of sharp edges and the like. It will be understood that the distal end 43 is substantially centered and uniform, however other variations are contemplated. The distal end 43 is oriented, preferably, so that the peak region 52 coincides with the top of the bag with the valley region 58 coinciding with the bottom of the bag. Preferably, the peak region 52 is positioned to coincide with the upper opening, although an offset or slightly twisted configuration is likewise contemplated. In this manner, the peak region 52 is preferably contacting a downward bend in a valve dispensing member before another portion of the hose.

In operation, the user is typically utilizing such a bag within a vessel or urn 100 configured to dispense fluid through valve dispensing member 102. Often, it is desirable to provide a urn and dispensing member that can be reused without being in contact with the product to be dispensed. The product only contacts the interior cavity of the bag and the elongated passage of the hose spout. In that manner, as desired, the bag can be replaced without the need to clean or sanitize the vessel and the valve dispensing member.

To prepare the urn for use in an embodiment of FIG. 7, the user first inserts the bag and hose spout into the inner cavity 104 of the vessel 100. The bag is directed downward with the hose spout 12 being directed into the valve dispensing member 102. It will be understood that the valve dispensing member 102 operates by selectively pinching and releasing the elongated spout, as desired. Such valves are well known in the art, and without limitation, such a valve is disclosed in U.S. Pat. No. 3,976,277 issued to Basel et al., which is also incorporated by reference in its entirety. Of course, other valve structures are likewise contemplated for use.

With the embodiment of FIGS. 8 through 10, as the hose spout is directed into the valve dispensing member 102, the distal end 43 essentially functions as the guide therethrough. It has been found that the ease of passage through the valve dispensing member 102 can be achieved through the configuration shown in these drawings. In such an embodiment, the peak region 52 contacts the valve dispensing member 102, generally at a bend. As the bends are generally in a downward direction, the peak region 52 is configured to coincide with the upper end of the bag, and thus, is the point of contact with a downwardly directed bend. Such a configuration of the distal end 43 precludes the jamming of the hose through the valve dispensing member and facilitates the smooth passage therethrough.

Once the bag is positioned within the vessel, and the hose spout is directed through the valve dispensing member, the upper perimeter of the bag can be extended up and over the upper edge 106 of the vessel and over the outside of the vessel. In an embodiment wherein the bag has a top seal, the bag can be cut or otherwise slit below the top seal and the top seal can be discarded, resulting in an open top bag. A rubber band, or other structure can be utilized over the bag to sandwich the bag between the rubber band and the outside surface of the vessel. In other embodiments, the respective size of the bag and dimension of the bag relative to the vessel will allow the bag to remain in the overlying orientation. In still other embodiments, an adhesive may be utilized.

Next, the user can insure that the distal end of the elongated spout 44 is prepared for dispensing. That is, if the distal end is closed, the user can cut or otherwise secure an opening on the distal end. In embodiments that already have an open end, this is not necessary. Additionally, prior to filling, the user should insure that the valve dispensing member is in the proper orientation, that is, that it is in the off position so that the fluid that is being introduced into the bag does not undesirably exit through the hose spout.

Once prepared, the user can introduce the desired fluid into the cavity of the bag. In certain embodiments, the ready to serve fluid can be placed directly into the bag. In other embodiments, the user may use the bag as a mixing chamber, wherein different constituents can be separately introduced and mixed within the bag. Once mixed, they can be dispensed.

Advantageously, due to the configuration of the hose spout, the spout is generally free from binding or otherwise being undesirably pinched while being inserted and properly positioned. In addition, the flexibility of the flange further facilitates the positioning of the bag in an orientation that is most conducive for dispensing. In addition, the flexibility of the flange also helps to preserve the integrity of the flange to bag, that is, bag to spout, connection regardless of the orientation and positioning within the vessel. Moreover, by having the entire structure of a flexible material, damage to adjacent bags due to shipping and handling can be minimized.

Another embodiment of the flexible package 209 is shown. Where structures of the dispensing bag are substantially identical to those of the embodiment shown in FIGS. 1 and 2, the same reference numbers have been utilized. Similarly, it will be understood that the spout of FIGS. 3 through 6 and 8 through 10 can be utilized for flexible package 209, and preferably, the spouts of FIGS. 8 through 10, as is shown.

In such a configuration, rather than attaching the hose spout to the outside surface of the front panel 20 (and generally centrally located between the first side seal and the second side seal), the hose spout is sealed to the inner surface 32 of the front panel 20 in a particular configuration, which will be described hereinbelow.

More particularly, the hose spout is positioned within the bag so that the elongated spout 44 extended through the opening 26 in the dispensing bag. Such insertion results in the outer surface 49 of the flange 40 being abuttingly positioned relative to the inner surface 32 of the front panel 20. The outer surface 49 of the flange is then sealingly coupled to the inner surface 32 of the front panel 20 in a fluid tight engagement forming a seal 70. Such a seal may be formed through heat, RF welding, adhering, ultrasonic welding or the like. It has been found that a substantially planar sealing portion, and preferably, a substantially planar flange 40 provides a lie flat bag that has good sealing characteristics.

More particularly, the seal is positioned so as to be spaced apart from an outer perimeter 71 of the flange 40 and also to be spaced apart from the transition region 42. The opening 26 is such that it is spaced apart from the transition region 42 and is sized so as to be larger than the transition region so as to be spaced apart therefrom. The seal is preferably substantially concentric with the opening 26 and the outer perimeter 71 of the flange, and generally comprises a substantially uniform thickness. Preferably, the seal is positioned axially midway between the transition region 42 and the outer perimeter 71. Variations are contemplated, however, it has been found that such a configuration, with such a flexible member provides protection to the seal when inserted into operation within the valve dispensing member 102 of the urn 100.

Additionally, it has been found that locating the hose spout relative to the dispensing bag in a particular orientation results in enhanced operation within the urn. For example, by spacing the spout relative to the seals in the manner shown, performance and minimization of creases and abrasion to the flange to bag seal can be achieved while utilizing a pillow type bag construction. Additionally, the outer perimeter 71 is protective of the seal that couples the flange to the bag.

More particularly, the opening 26 is positioned toward a corner of the bag wherein one of the first side seal and the second side seal meet the bottom seal. In the configuration shown, the opening 26 is positioned proximate the corner of the bag wherein the second side seal meets the bottom seal. Additionally, the opening is closer to the second side seal than to the bottom seal. In the configuration shown, the opening 26 is spaced apart from the second side seal a distance of 2.375 inches, and the opening 26 is spaced apart from the bottom seal a distance of 3.375 inches.

Additionally, the position of the peak region 52 (i.e., the longest end of the elongated spout) is oriented toward the bottom seal. Such a configuration insures proper insertion into the valve dispensing member and the proper guidance of the elongated spout through the valve dispensing member merely by positioning the bag within the urn 100. Other configurations are contemplated, however, it has been found that such a configuration provides surprisingly proper positioning with minimum effort or guidance.

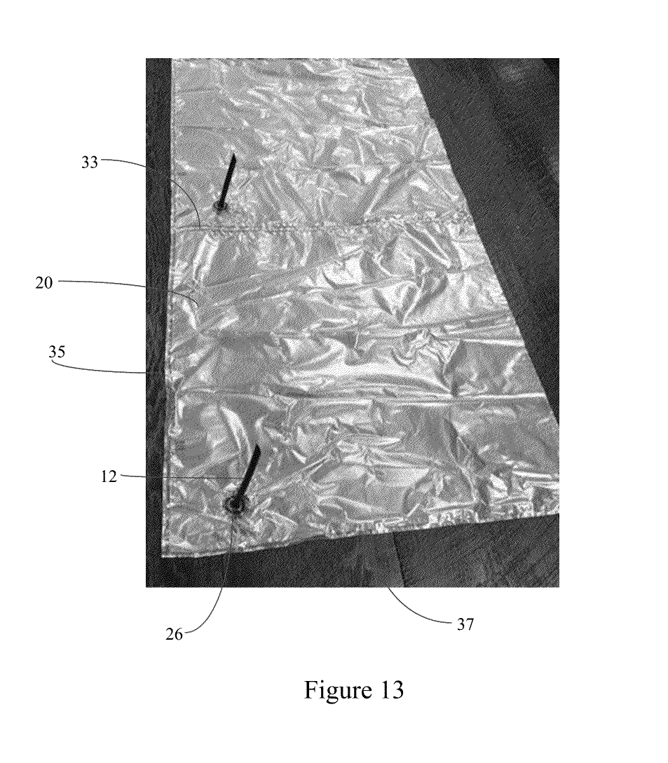

In such a configuration, the bag as shown has a width of 23.75″ between the first side seal and the second side seal, and a height of 23.5″ between the bottom seal and the open top edge. It will also be understood and see by way of FIG. 13, the flexible bags are produced in a side by side configuration, wherein the second side seal of one bag is positioned proximate a first side seal of an adjacent bag with a perforation therebetween. In some configurations, the hose spout may be positioned within the bag prior to formation, and may be extended through, positioned in the proper orientation and sealed to the inner surface of the bag after the bag is formed. In other configurations, the hose spout may be positioned in the proper orientation and sealed to the inner surface of the bag whereupon the combined front panel and spout can be coupled to the back panel to form the dispensing bag.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A flexible package for positionable within a vessel having an outlet controlled by a valve dispensing member, the flexible package comprising:
a dispensing bag including at least one panel and at least one seal defining a cavity with an open top, and an opening extending through the at least one panel spaced apart from the open top and spaced apart from the at least one seal, the panel including an inner surface surrounding the opening, and an outer surface surrounding the opening;
a hose spout including an integrally molded flange and elongated spout of a uniform material, the elongated spout extending from the molded flange and together defining an elongated channel with a proximal end and a distal end, the proximal end corresponding to the molded flange, the molded flange having an outer surface, the outer surface of the molded flange being coupled to the inner surface of the dispensing bag by a seal with the elongated spout extending through the opening thereof.

2. The flexible package of claim 1 wherein:
the at least one panel comprises a front panel and a back panel, and the at least one seal includes a bottom seal and opposing first and second side seals extending therefrom, the panels and the at least one seal defining an open top opposite the bottom seal, defining a substantially rectangular pillow bag.

3. The flexible package of claim 2 wherein:
the opening is positioned on the front panel closer to one of the first side seal and the second side seal from the other of the first side seal and the second side seal, and closer to the bottom seal than the open top, while being spaced apart from each of the first side seal, the second side seal and the bottom seal.

4. The flexible package of claim 3 wherein the opening is positioned closer to one of the first side seal and the second side seal than to the bottom seal.

5. The flexible package of claim 4 wherein the opening is positioned closest to the second side seal, than to the bottom seal and closer to the bottom seal than the first side seal.

6. The flexible package of claim 5 wherein the seal is spaced apart from an outer perimeter of the flange of the hose spout, and spaced apart from the opening in the front panel.

7. The flexible package of claim 6 wherein the hose spout includes a transition region that joins the elongated spout and the flange, wherein the transition region has a diameter greater than the elongated spout, wherein the opening in the front panel is larger than the transition region of the hose spout so as to be spaced apart therefrom.

8. The flexible package of claim 7 wherein the flange is substantially planar with the elongated spout being substantially perpendicular thereto.

9. The flexible package of claim 5 wherein the elongated spout includes a peak region, with the peak region oriented toward the bottom seal of the dispensing bag.

10. The flexible package of claim 9 wherein the peak region defines a point.

11. The flexible package of claim 9 wherein the outer surface of the flange is substantially planar with the elongated spout being substantially perpendicular thereof.

12. The flexible package of claim 11 wherein the elongated spout is multiple times longer than a largest dimension of the flange.

13. The flexible package of claim 12 wherein the flange is substantially circular, with the elongated spout being substantially perpendicular thereto.

14. The flexible package of claim 1 wherein the flange has a thickness that is greater than a thickness of the at least one panel about the opening.

15. The flexible package of claim 1 wherein the seal is a heat seal.
